(19) United States
(12) Patent Application Publication
(10) Pub. No.: US 2015/0084467 A1
(43) Pub. Date: Mar. 26, 2015

(54) Reduced Reaction Rotary Alternating Current Generator

(71) Applicant: Tewari Paramahamsa, Gotegali (IN)

(72) Inventor: Tewari Paramahamsa, Gotegali (IN)

(21) Appl. No.: 14/251,908

(22) Filed: Apr. 14, 2014

Related U.S. Application Data
(60) Provisional application No. 61/960,752, filed on Sep. 26, 2013.

(51) Int. Cl. H02K 1/27

(52) U.S. Cl. CPC H02K 1/272
USPC 310/156.43

(57) ABSTRACT

A reduced reaction alternating current generator including a hollow stator core, a cylindrical rotor within the stator, a freely rotating shaft coupled to the rotor, a first set of magnets in which the south pole of each magnet is coupled to the surface to the rotor and the north pole of each magnet is facing the inner surface of the hollow stator core, a second set of magnets in which the north pole of each magnet is coupled to the surface of the rotor and the south pole of each magnet is facing the inner surface of the hollow stator core and a set of silicon steel pieces coupled to the outer surface of the rotor comprised of individual silicon steel pieces positioned adjacent to and longitudinally in line with each individual magnet within the first set of magnets and each individual magnet within the second set of magnets.

### RELATED APPLICATION

This application claims the benefit of U.S. provisional patent application No. 61/960,752, filed Sep. 26, 2013, in the name of Paramahamsa Tewari, the disclosure of which is incorporated herein by reference.

### FIELD OF THE INVENTION

The present invention relates to a rotating alternating current generator whose structural characteristic provide for a reduction in the amount force running counter to the rotation of the machine as a reaction to the induced alternating current.

### BACKGROUND OF THE INVENTION

Michael Faraday discovered the principles of electromagnetic induction and invented the rotating electrical generator in 1832. The generator was known as the Unipolar Generator, Acyclic Generator and Disk Generator. This generator operated on the principle that voltage is induced in a conductor in relative motion to an external magnetic field. Moreover, when the conductor is configured as a closed circuit and is in relative motion with an external magnetic field, a current will be induced to flow through that circuit. The induced current itself will generate an induced magnetic field surrounding the conductor. The direction of the induced current is determined by Fleming's right hand rule which states that the magnetic field produced by the current induced in the conductor will repel the external magnetic field which induced the current in the conductor. As such, the induced magnetic field surrounding the conductor and the external magnetic field repel each other so as to create a torque on the conductor which counters that conductor's movement relative to the external magnetic field. Faraday's generator and all subsequent generators have in common the production of this counter or back torque.

The efficiency of an electrical generator is governed by mechanical and electrical limitations. The mechanical limitations include windage and friction of the generator's rotor and bearings. The electrical limitations include electrical impedance within the windings of the generator as well as the above-described counter or back torque.

A prime mover is attached to a generator so as to cause the rotation of the generator's rotor resulting in the production of either a direct or an alternating current within the generator's conductor and a back torque which counters the rotation caused by the prime mover. The prime mover may be powered by steam, wind or water.

Therefore, the problem with standard generators is that their efficiency is limited due to back torque generated as a result of current induced within the generator's conductor windings.

### DEFINITIONS

The following definitions are provided for convenience and are not to be taken as a limitation of the present invention.

Fleming's Left Hand Rule refers to the effect that when a current flows in a conductor and an external magnetic field is applied across that current flow, the conductor will experience a force perpendicular to both the external magnetic field and the direction of the current flow. The Left Hand Rule can be used to represent three mutually orthogonal axes using the thumb to represent a mechanical force, the first finger to represent a magnetic field and the middle finger to represent the current, each finger positioned at right angles to each other.

Synchronous generator refers to an electrical generator which turns at the same speed as the drive mechanism, also known as the synchronous speed. A synchronous generator produces an alternating current and voltage at a frequency proportional to the rotation speed and to the number of excitation poles internal to the generator.

Asynchronous generator refers to an alternating current generator that uses the principles of induction to produce power. Asynchronous generators operate by mechanically turning their rotor faster than the synchronous speed, giving negative slip.

Low carbon steel refers to steel containing less carbon than other steels. This steel is inherently easier to cold-form due to its soft and ductile nature.

Grain oriented electrical steel refers to sheet steel used for laminations in power transformers having a silicon level of 3% or less.

### SUMMARY OF THE INVENTION

It is the primary purpose of the present invention to obviate the above problems by providing a reduced reaction rotating alternating current generator providing improvement in efficiency characteristics not currently available in standard alternating current generators.

To accomplish this objective, according to one embodiment of the present invention a reduced reaction alternating current generator is disclosed comprising a hollow stator core having an axis comprised of longitudinally positioned sheets laminated with a high permeability magnetic material, the laminated sheets including longitudinally embedded slots in which a conductor winding is laid parallel to the axis, a cylindrical rotor concentric with and positioned inside the hollow stator core comprised of a high permeability magnetic material and a shaft coupled to the rotor and driven by an external source so as to freely rotate the rotor relative to the hollow stator core. The generator furthermore comprising a first set of magnets in which the south pole of each magnet is coupled to the surface to the rotor and the north pole of each magnet is facing the inner surface of the hollow stator core, a second set of magnets in which the north pole of each magnet is coupled to the surface of the rotor and the south pole of each magnet is facing the inner surface of the hollow stator core and a set of silicon steel pieces coupled to the outer surface of the rotor comprised of individual silicon steel pieces positioned adjacent to and longitudinally in line with each individual magnet within the first set of magnets and each individual magnet within the second set of magnets.

In addition to the foregoing, other features, objects and advantages of the present invention will become apparent from the following description.

### BRIEF DESCRIPTION OF THE DRAWINGS

The following detailed description, given by way of example and not intended to limit the present invention solely thereto, will best be appreciated in conjunction with the accompanying drawings in which:

FIG. 1 depicts a longitudinal cross sectional view of a reduced reaction alternating current generator according to an exemplary embodiment of the present invention;

FIG. 2 depicts an end cross sectional view of a reduced reaction alternating current generator according to an exemplary embodiment of the present invention;

FIG. 3 depicts a center cross sectional view of a reduced reaction alternating current generator according to an exemplary embodiment of the present invention;

FIG. 4 depicts a longitudinal cross sectional view of the flow of magnetic fields emanating from the first set of magnets within a reduced reaction generator according to an exemplary embodiment of the present invention;

FIGS. 5 and 6 depict the interaction between the magnetic flux originating from the north poles of the first set of magnets and the magnetic flux resulting from an induced current in the conductor winding according to an exemplary embodiment of the present invention;

FIG. 7 depicts a longitudinal cross sectional view of the flow of magnetic fields emanating from the second set of magnets within a reduced reaction generator accordance to an exemplary embodiment of the present invention; and

FIGS. 8 and 9 depict the interaction between the magnetic flux originating from the south poles of the second set of magnets and the magnetic flux resulting from an induced current in the conductor winding according to an exemplary embodiment of the present invention.

### DETAILED DESCRIPTION OF THE INVENTION

The present invention relates to a reduced reaction rotating alternating current generator providing improvement in efficiency characteristics not currently available in standard alternating current generators.

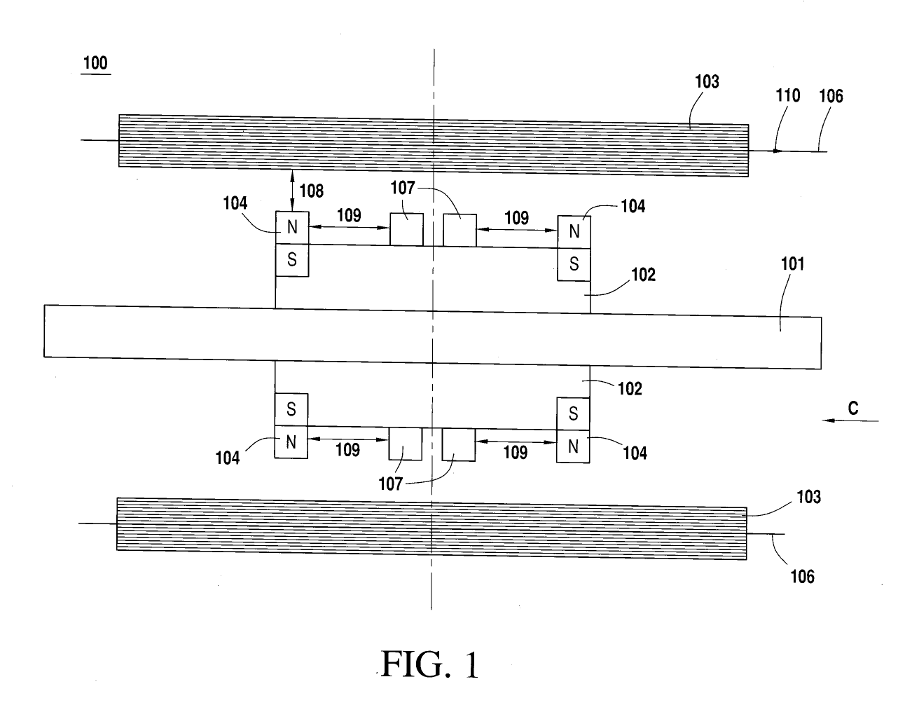

FIG. 1 depicts a longitudinal cross sectional view of a reduced reaction alternating current generator according to an exemplary embodiment of the present invention. As shown by FIG. 1, the induction machine 100 comprises a shaft 101, a rotor 102, a stator 103, a first set of magnets 104, a second set of magnets 105 (not shown), a conductor winding 106 and silicon steel pieces 107.

The rotor 102 is a cylinder of high permeability magnetic material attached directly to the shaft 101 using any conventional known method that provides for a secure and permanent bonding under normal operating conditions. The rotor 102 is sized to be fully encompassed within the stator 103 while the shaft 101 is sized to extend beyond at least one end of the stator 103.

The shaft 101 is mounted within the stator 103 so as to allow the shaft 101 and the attached rotor 102 to rotate freely within the stator 103 when the shaft 101 is driven by an external drive source. The external drive source is coupled to one end of the shaft 101 that extends beyond the stator 103. The external drive source may be driven either at a variable speed or at a synchronous speed. As such the drive source may be an alternating current (AC) based source or a direct current (DC) based source. The drive source may also be a non-electric based drive source such as a hydro, wind or an internal combustion based source. The means of coupling the drive source to the shaft 101 will be dependent on the type drive source and any conventional know means appropriate to the drive source type may be implemented.

In an exemplary embodiment, the shaft is two 30 mm diameter 1018 steel, the rotor is 370 mm diameter 1018 steel and the stator has a 570 mm diameter.

Provisions are made on the cylindrical surface of the rotor 102 for the mounting of the first set magnets 104 and for the mounting of the second set of magnets 105 near each of the ends of the rotor 102. Provisions are also made for the mounting of the silicon steel pieces 107 on the rotor at positions near the center of the rotor.

The first set of magnets 104 and the second set of magnets 105 (not shown) are attached to the ends of the rotor 102 cylinder using any conventionally method known to provide for a secure and permanent bonding under normal operating conditions. Each end of the rotor 102 contains one of the first set of magnets 104 and one of the second set of magnets 105, for a total of four magnets. The first set of magnets 104 are oriented with their north poles facing the stator 103 and their south poles coupled to the rotor 102. The second set of magnets 105 (not shown) are oriented with their south poles facing the stator 103 and their north poles coupled to the rotor 102. The magnets may be permanent magnets or electromagnets.

In an exemplary embodiment, the permanent magnets are Neodymium magnets with a maximum energy product (BHₘₐₓ) of 48 to 50 MGOe. Moreover, in another exemplary embodiment the electromagnets are radial pole and are attached to the rotor in a manner generally known in the industry.

The silicon steel pieces 107 are also attached to the rotor 102 using any conventionally method known to provide for a secure and permanent bonding under normal operating conditions. There is a single silicon steel piece 107 corresponding to each magnet of the first and second sets of magnets 104 attached to the rotor 102. Each silicon steel piece 107 is positioned in line with its corresponding magnet leaving a predefined distance 109 between silicon steel piece and its corresponding magnet. Each silicon steel piece 107 is comprised of silicon steel which is a specialty steel tailored to have a small magnetic hysteresis area and high magnetic permeability. A high magnetic permeability is defined as having a magnetic saturation level above 1.8 Teslas.

In an exemplary embodiment, the first and second sets of magnets 104, 105 and the silicon steel pieces 107 are each sized to have approximately the same surface area and the distance 109 between silicon steel piece and a corresponding magnet is no more than the length of the magnet in the axial plane.

The rotor 102 and the attached magnets 104, 105 and steel pieces 107 are each sized as to provide for an air-gap 108 of a predefined size between the outer surfaces of the attached magnets 104, 105 and silicon steel pieces 107 and the inner surface of the stator 103. The air gap is sized to provide for the free rotation of the rotor 102 and the attached first and second sets of magnets 104, 105 within the stator 103 as well as the efficient flow of magnetic flux into and out of the stator 103 across the air-gap 108.

In an exemplary embodiment, the air-gap 108 is within a range of 3 mm to 10 mm.

The stator 103 is composed of longitudinally placed silicon steel laminates having grains oriented along the path of the magnetic flux that enters and exits the stator 103. The stator 103 also includes longitudinally oriented slots in which the conductor winding 106 is laid, the conductor winding 106 positioned such as to be cut through by the rotating magnetic flux originating from the first and second sets of magnets 104 attached to the rotating motor 102.

In an exemplary embodiment, the stator is comprised of a magnetically inert material, such as PVC piping, of suitable strength to support grain oriented steel lamination sheets.

In an exemplary embodiment, the magnetic flux emanating from the first and second magnets is approximately 10,000 Gauss.

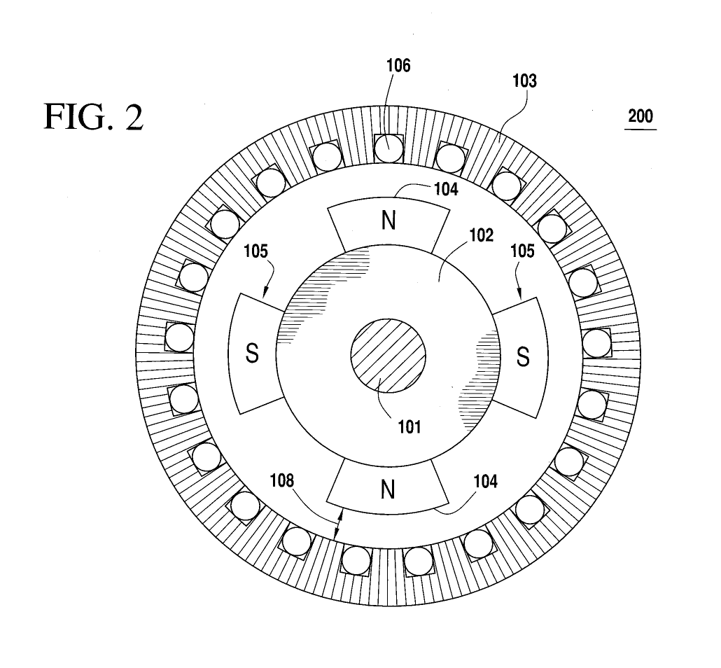

FIG. 2 depicts an end cross sectional view of a reduced reaction alternating current generator according to an exemplary embodiment of the present invention. As shown by FIG. 2, the first set of magnets 104 with their north poles facing the stator 103 and their south poles coupled to the rotor 102 are positioned at opposing in-line positions on one end of the rotor 102.

Similarly, the second set of magnets 105 with their south poles facing the stator 103 and their north poles coupled to the rotor 102 are positioned at opposing in-line positions on the same end of the rotor 102 at a ninety degree offset from the first set of magnets 104. An identical first set of magnets 104 and second set of magnets 105 are coupled to the other end of the rotor 102 at similar positions.

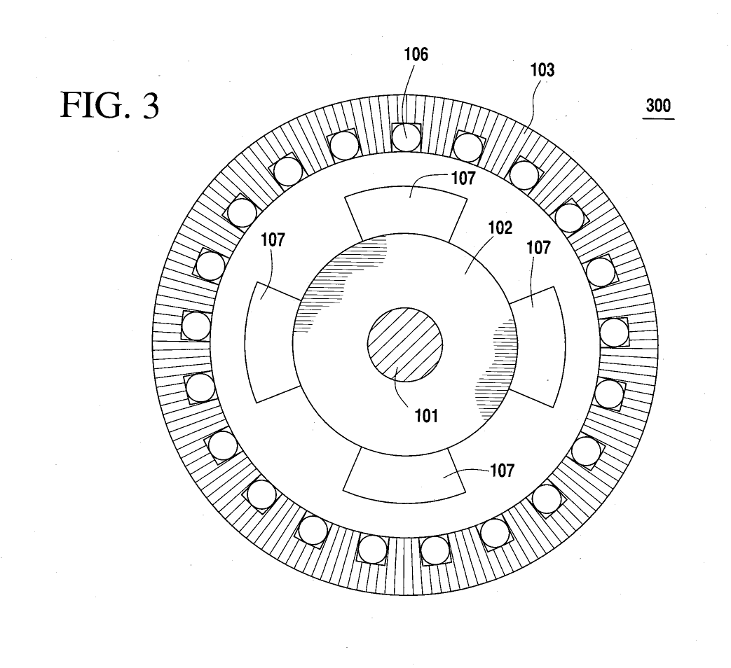

FIG. 3 depicts a center cross sectional view of a reduced reaction alternating current generator according to an exemplary embodiment of the present invention. As shown by FIG. 3, a single silicon steel piece 107 is positioned longitudinally in line with each magnet of the first and second sets of magnets 104, 105 (not shown). The position of each silicon steel piece 107 provides for a predefined distance 108 between a silicon steel piece 107 and its corresponding magnet.

In an exemplary embodiment, the distance between a silicon steel piece 107 and its corresponding magnet is equal to the longitudinal length of the magnet.

Referring again to FIG. 1, an electromagnetic force (EMF) is created across the conductor winding 106 embedded within the stator 103 when the magnetic flux emanating from the first set of magnets 104 and from the second set of magnets 105 cut through the conductor winding 106 as the rotor 102 rotates. Looking in the direction of arrow C in FIG. 1, with the rotor 102 turning in a clockwise direction and the magnetic flux emanating in a vertically upward direction from the north poles of the first set of magnets 104, the current generated as a result of the induced electromagnetic force will travel from left to right 110 within the conductor winding 106.

The current direction is as per Lenz's Law which states when an electric current is induced in a conductor, the direction of the induced current is such that its magnetic effect will oppose the action that gives rise to the induced current. As such, the direction of the induced current 110 results in a torque such as to oppose the clockwise rotation of the rotor 102. Specifically, looking in the direction of the arrow C in FIG. 1, the interaction between the counter-clockwise magnetic field surrounding the conductor as a result of the induced electromagnetic force and the upward magnetic flux emanating from the north poles first pair of magnets 104 will create a counter-clockwise torque opposing the clockwise rotation of the rotor 102.

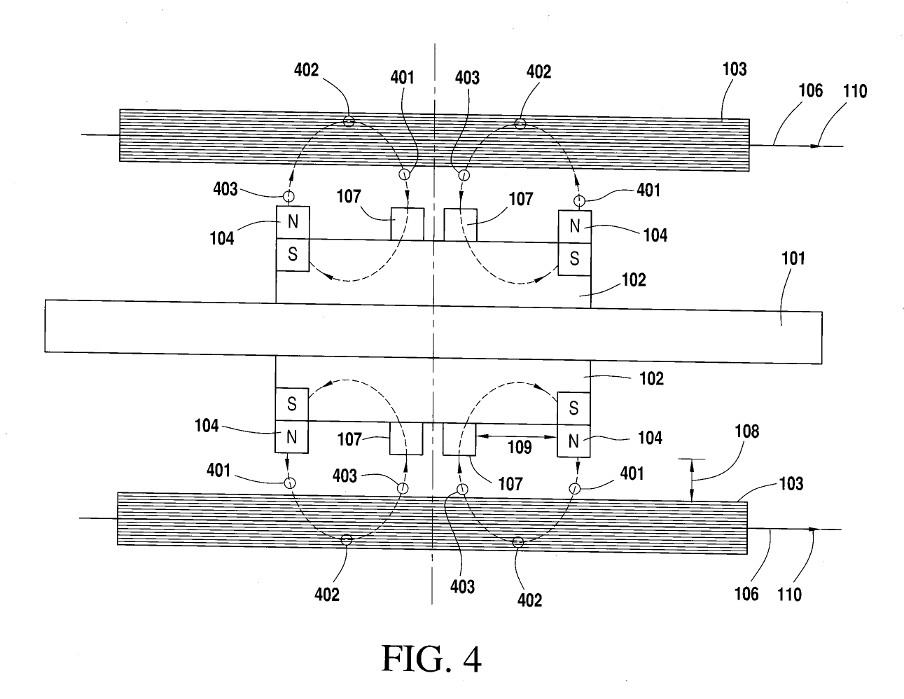

FIG. 4 depicts a longitudinal cross sectional view of the flow of magnetic fields emanating from the first set of magnets within a reduced reaction generator according to an exemplary embodiment of the present invention. As shown by FIG. 4, the magnetic flux 401 emanating from the north poles of the first set of magnets 104 travels vertically upward, across the air gap 108 and into the stator 103 as the magnetic flux 401 rotates with the rotor 102 relative to the stator 103. As this rotating magnetic flux 401 enters the static stator 103, it cuts sideways across the conductor winding 106 embedded within the stator 103 and induces a current within the conductor winding 106.

Within the stator 103, a portion of magnetic flux 402 is now trapped within the grain stampings within the stator 103 and flows longitudinally in an effort to return to a corresponding south pole of the first set of magnets 104. This portion of the magnetic flux 402 is now static relative to the stator 103 and the embedded conductor winding 106. As such, this portion of the magnetic flux 402 flows through and exits the stator 103 without any sideways movement relative to the embedded conductor winding 106 and therefore without inducing a current within the conductor winding 106.

Outside of the stator 103, a portion of the magnetic flux 403 crosses the air gap 108 and reaches the surface of a corresponding steel piece 107. The steel piece 107 focuses the magnetic flux 403 within the air gap 108 providing a more efficient and specifically designed path for the magnetic flux 403 to return to a corresponding first set of magnets 104. The magnetic flux 403 passes through the steel piece 107 and returns to a corresponding south pole of the first set of magnets 104 thereby closing the magnetic flux loop between north and south poles of each magnet of the first set of magnets 104.

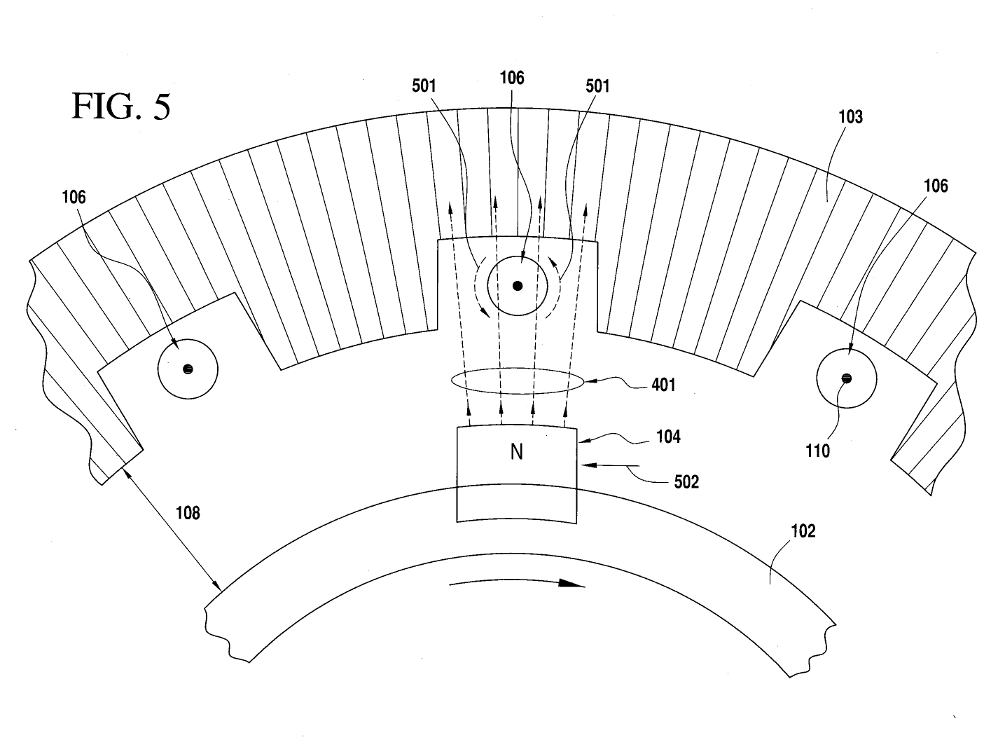

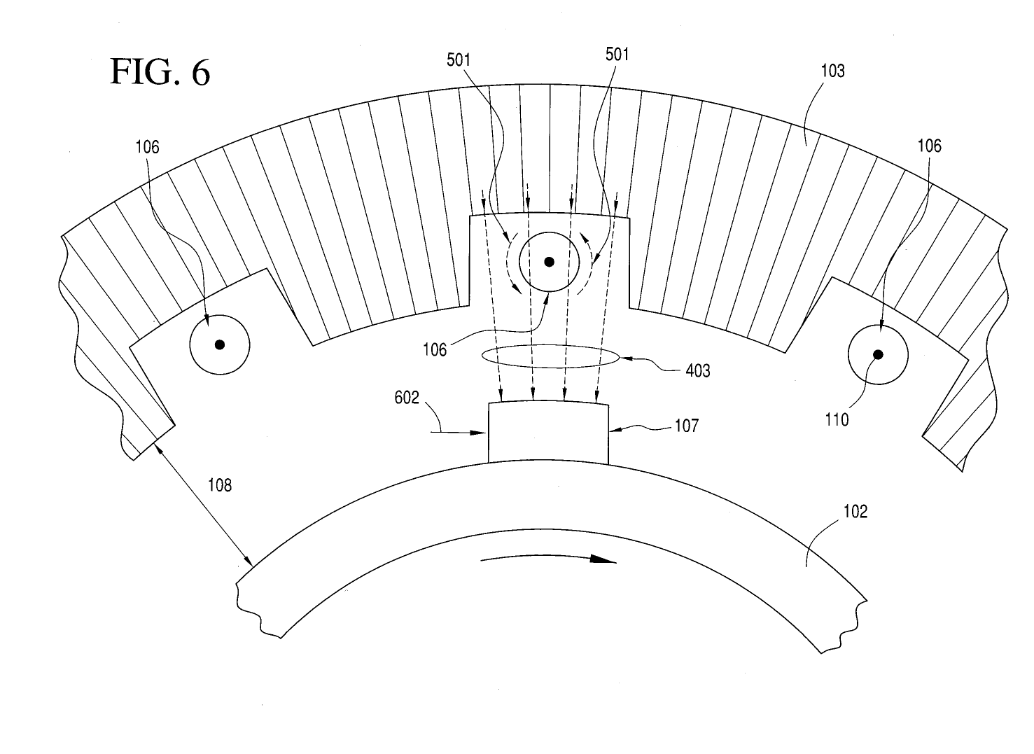

FIGS. 5 and 6 depict the interaction between the magnetic flux originating from the north poles of the first set of magnets and the magnetic flux resulting from an induced current in the conductor winding according to an exemplary embodiment of the present invention. In both FIGS. 5 and 6, the current 110 induced in the conductor winding 106 by the clockwise rotation of the rotor 102 is shown coming out of the page. Moreover, in accordance with the application of the right hand rule, the magnetic flux 501 surrounding the conductor winding 106 as a result of the induced current 110 is shown as having a counter-clockwise rotation.

In FIG. 5, the magnetic flux originating from the first set of magnets is shown traversing the air gap in an upward direction and interacting with the magnetic flux surrounding the conductor winding. As shown by FIG. 5, the magnetic field 401 originating from the first set of magnets 104 is strengthened on the right side of the conductor winding 106 due to the superimposition of the magnetic field 501 induced in the conductor winding 106 in the same direction. However, the magnetic field 401 origination from the first set of magnets 104 is weakened on the left side of the conductor winding 106 due to the superimposition of the magnetic field 501 induced in the conductor winding 106 in the opposite direction. As a result of this interaction, the net magnetic field in the air-gap 108 over the surfaces of the first set of magnets 104 results in the application of a counter-clockwise torque 502 to the rotor 102 which opposes the clockwise rotation of the rotor 102. This is in accordance with Lenz's Law and is confirmed by the right hand rule which shows that a conductor within an upward directed magnetic field and carrying a current in the induced direction (coming out of the page) will experience a counter-clockwise force.

In FIG. 6, the portion of the magnetic flux that is routed back from the stator, downward across the air gap and through a silicon steel piece is shown interacting with the induced magnetic flux surrounding the conductor winding. As shown by FIG. 6, the magnetic field 403 routed down through the silicon steel piece 107 is strengthened on the left side of the conductor winding 106 due to the superimposition of the magnetic field 501 induced in the conductor winding 106 in the same direction. However, the magnetic field 403 is weakened on the right side of the conductor winding 106 due to the superimposition of the magnetic field 501 induced in the conductor winding 106 in the opposite direction. As a result, on the surface of the silicon steel piece 107, the magnetic field 403 develops a gradient from left to right thus creating a clockwise torque 602 which supports the clockwise rotation of the rotor 102. This is in accordance with Lenz's Law and is confirmed by the right hand rule which shows that a conductor winding 106 within a downward directed magnetic field 403 and carrying a current 110 in the induced direction (coming out of the page) will experience a clockwise force.

Therefore, as a result of this configuration, the conductor winding 106 embedded within the stator 103 is cut at two places by each magnetic flux originating from the north pole of the first set of magnets 104. Specifically, a first time when the magnetic field 401 enters the stator 103 in an upward direction and a second time when the magnetic field 403 exits the stator 103 in a downward direction through a silicon steel piece 107. The net effect is that the clockwise torque generated by the magnetic field 403 rerouted through the silicon steel pieces 107 partially cancels the counter-clockwise torque generated by the magnetic field 401 originating from the north poles of the first set of magnets 104. This results in a partial nullification of the back torque reaction caused by the effect of Lenz's Law reaction and results in a corresponding increase in the efficiency of the machine because the external drive source has to supply less torque to overcome the reduced reaction of the machine.

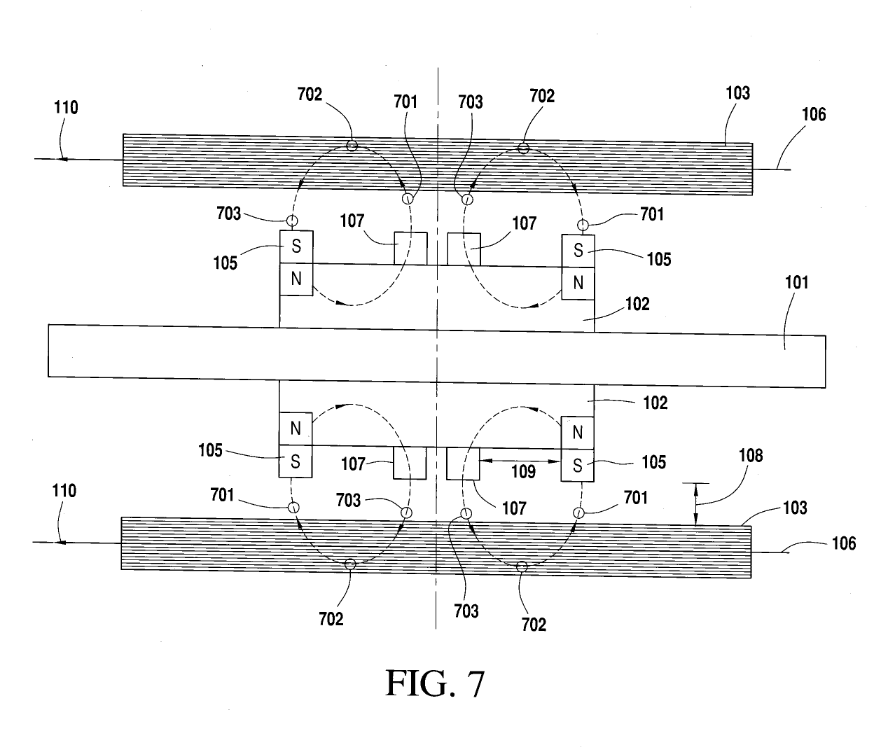

FIG. 7 depicts a longitudinal cross sectional view of the flow of magnetic fields emanating from the second set of magnets within a reduced reaction generator according to an exemplary embodiment of the present invention. As shown by FIG. 7, the magnetic flux 701 flowing into the south pole of the second set of the magnets 105 travels vertically downward from within the stator 103 and across the air gap 108 as the magnetic flux 701 rotates with the rotor 102 relative to the stator 103. As this rotating magnetic flux 701 exits the static stator 103, it cuts sideways across the conductor winding 106 embedded within the stator 103 and induces a current within that conductor winding 106.

Within the stator 103, a portion of the magnetic flux 702 flows longitudinally along the grain stampings within the stator 103 from a position where the magnetic flux 702 enters the stator 103. This portion of the magnetic flux 702 is static relative to the stator 103 and to the conductor winding 106 embedded within the stator 103. As such, this portion of the magnetic flux 702 enters and flows through the stator 103 without any sideways movement relative to the embedded conductor winding 106 and, therefore, without inducing a current within the conductor winding 106.

Outside of the stator 103, a portion of the magnetic flux 703 flows from a north pole of the second set of magnets 105, through a corresponding silicon steel piece 107, upward across the air gap 108 and into the stator 103. The silicon steel piece 107 focuses the magnetic flux 703 within the air gap 108 providing a more efficient and specifically designed path for the magnetic flux 703 originating from a corresponding second set of magnets 105. The magnetic flux 703 exists the steel piece 107 and enters the stator 103 thereby closing the magnetic flux loop between the south and north poles of each magnet of the second set of magnets 105.

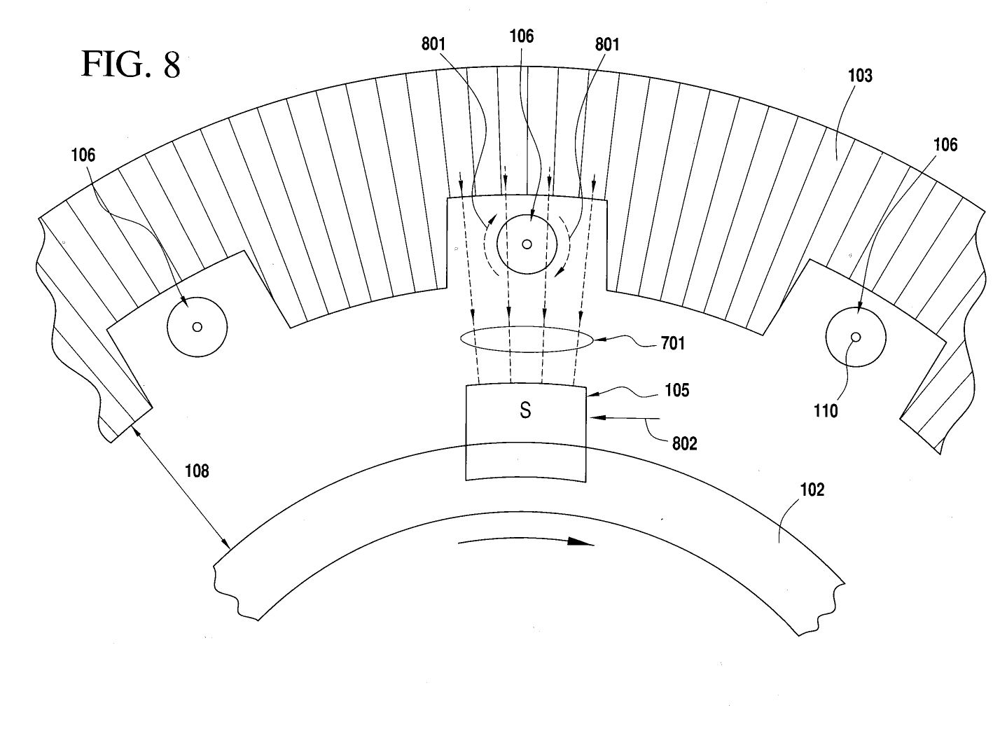

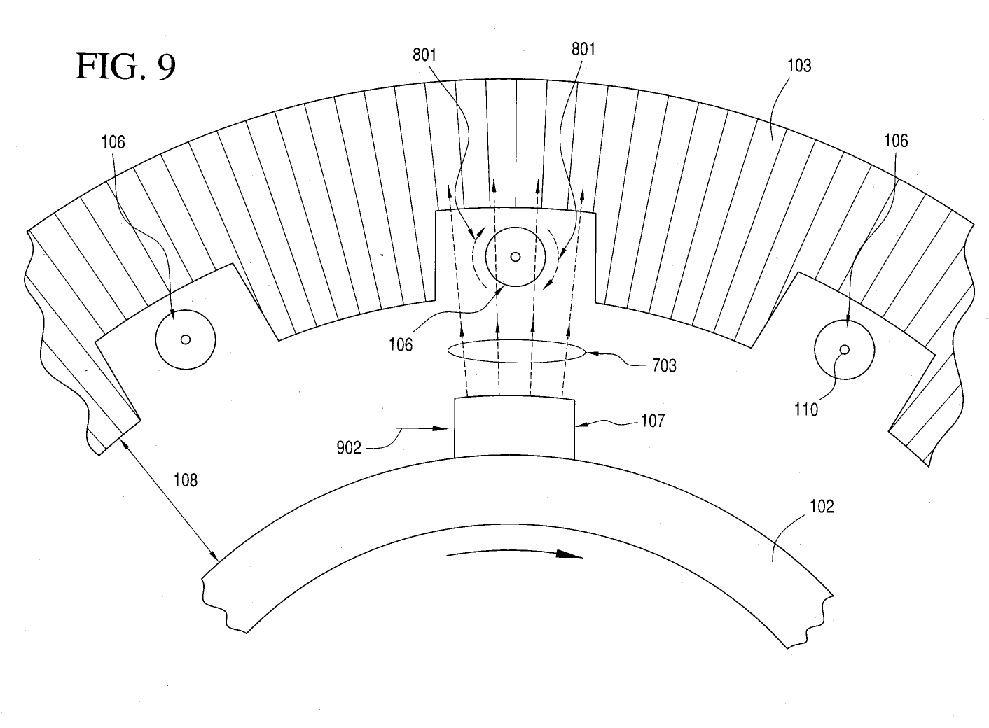

FIGS. 8 and 9 depict the interaction between the magnetic flux originating from the south poles of the second set of magnets and the magnetic flux resulting from an induced current in the conductor winding according to an exemplary embodiment of the present invention. In both FIGS. 8 and 9, the current 110 induced in the conductor winding 106 by the clockwise rotation of the rotor 102 is shown as going into the page. Moreover, in accordance with the application of the right hand rule, the magnetic flux 801 surrounding the conductor winding 106 as a result of the induced current 110 is shown as having a clockwise rotation.

In FIG. 8, the magnetic flux originating from the second set of magnets is shown traversing the air gap in a downward direction and interacting the magnetic flux surrounding the conductor winding. As shown by FIG. 8, the magnetic field 701 originating from the second set of magnets 105 is strengthened on the right side of the conductor winding 106 due to the superimposition of the magnetic field 801 induced in the conductor winding 106 in the same direction. However, the magnetic field 701 originating from the second set of magnets 105 is weakened on the left side of the conductor winding 106 due to the superimposition of the magnetic fields 801 induced in the conductor winding 106 in the opposite direction. As a result of this interaction, the net magnetic field in the air-gap over the surfaces of the second set of magnets 105 results in the application of a counter-clockwise torque 802 to the rotor 102 which opposes the clockwise rotation of the rotor 102. This is in accordance with Lenz's Law and is confirmed by the right hand rule which shows that a conductor within a downward directed magnetic field and carrying a current in the induced direction (going into the page) will experience a counter-clockwise force.

In FIG. 9, the portion of the magnetic flux originally routed through the steel pieces 107, across the air gap 108 and into the stator is shown interacting with the induced magnetic flux surrounding the conductor winding. As shown by FIG. 9, the magnetic field 703 routed upwardly through a steel piece 107 and across the air gap 108 is strengthened on the left side of the conductor winding 106 due to the superimposition of the magnetic field 801 induced in the conductor winding 106 in the same direction. However, the magnetic field 703 is weakened on the right side of the conductor winding 106 due to the superimposition of the magnetic field 801 induced in the conductor winding 106 in the opposite direction. As a result, on the surface of the silicon steel piece 107, the magnetic field 703 develops a gradient from left to right thus creating a clockwise torque 902 which supports the clockwise rotation of the rotor 102. This is in accordance with Lenz's law and is confirmed by the right hand rule which shows that a conductor winding 106 within an upward directed magnetic field 703 and carrying a current 110 in the induced direction (going into the page) will experience a clockwise force.

Therefore, as a result of this configuration and as described above for the first set of magnets, the conductor embedded within the stator is cut at two places by each magnetic field terminating at the south pole of the second set of magnets. Specifically, a first time when the magnetic field 701 exits the stator 103 in a downward direction and a second time when the magnetic field 703 enters the stator 103 in an upward direction through a silicon steel piece 107. The net effect is that the clockwise torque generated by the magnetic field 703 rerouted through the silicon steel pieces 107 partially cancels the counter-clockwise torque generated by the magnetic field 701 terminating at the south pole of the second set of magnets 105. This results in a partial nullification of the back torque reaction caused by the effect of Lenz's Law reaction and results in a corresponding increase in the efficiency of the machine because the external drive source has to supply less torque to overcome the reduced reaction of the machine.

What is claimed:

1. A reduced reaction alternating current generator, comprising:
a hollow stator core having an axis comprised of longitudinally positioned sheets laminated with a high permeability magnetic material, the laminated sheets including longitudinally embedded slots in which a conductor winding is laid parallel to the axis;
a cylindrical rotor concentric with and positioned inside the hollow stator core comprised of a high permeability magnetic material;
a shaft coupled to the rotor and driven by an external source so as to freely rotate the rotor relative to the hollow stator core;
a first set of magnets in which the south pole of each magnet is coupled to the surface to the rotor and the north pole of each magnet is facing the inner surface of the hollow stator core;
a second set of magnets in which the north pole of each magnet is coupled to the surface of the rotor and the south pole of each magnet is facing the inner surface of the hollow stator core; and
a set of silicon steel pieces coupled to the outer surface of the rotor comprised of individual silicon steel pieces positioned adjacent to and longitudinally in line with each individual magnet within the first set of magnets and each individual magnet within the second set of magnets.

2. The reduced reaction alternating current generator of claim 1, wherein each silicon steel piece is positioned relative to a corresponding magnet to create magnetic circuit through the silicon steel piece and the corresponding magnet such that the magnetic flux emanating from each magnet is guided in one direction into the stator and then guided in an opposite direction out of the stator.

3. The reduced reaction alternating current generator of claim 1, wherein the silicon steel pieces are sized to have approximately the same surface area as the corresponding magnets.

4. The reduced reaction alternating current generator of claim 1, wherein the silicon steel pieces are positioned to provide for a gap between a silicon steel piece and a corresponding magnet, the gap being approximately equal to the longitudinal length of the corresponding magnet.

5. The reduced reaction alternating current generator of claim 1, wherein the first set of magnets and the second set of magnets are permanent magnets.

6. The reduced reaction alternating current generator of claim 5, wherein the permanent magnets can be Neodymium, Samarian Cobalt or Ceramic.

7. The reduced reaction alternating current generator of claim 1, wherein the first set of magnets and the second set of magnets are electromagnets.

8. The reduced reaction alternating current generator of claim 1, wherein the electromagnets are comprised of steel alloy having a high flux density of saturation.

9. The reduced reaction alternating current generator of claim 1, wherein the high permeability magnetic laminations which make up the stator are made from grain oriented electrical steel, the grains oriented as to facilitate the flow of magnetic flux between a magnet and a corresponding silicon steel piece.
